(19) United States
(12) Patent Application Publication
(10) Pub. No.: US 2026/0128675 A1
(43) Pub. Date: May 7, 2026

(54) MULTI-PHASE CONTROLLER WITH ULTRA LIGHT LOAD EXIT

(71) Applicant: SEMICONDUCTOR COMPONENTS INDUSTRIES, LLC, Scottsdale, AZ (US)

(72) Inventors: Liam HANMORE, Limerick (IE); Adrian WARD, Limerick (IE); David Kieran STACK, Meelick (IE)

(73) Assignee: SEMICONDUCTOR COMPONENTS INDUSTRIES, LLC, Scottsdale, AZ (US)

(21) Appl. No.: 19/355,487

(22) Filed: Oct. 10, 2025

Related U.S. Application Data
(60) Provisional application No. 63/717,600, filed on Nov. 7, 2024.

(51) Int. Cl. H02M 3/158; H02M 1/00

(52) U.S. Cl. CPC H02M 3/1584; H02M 1/0009

(57) ABSTRACT

A multi-phase controller is disclosed. The multi-phase controller includes a current-mode regulation circuit and a pulse distributor configured to distribute a first set of pulses to a first power stage and a second set of pulses to a second power stage, and to selectively enable or disable the second set of pulses to the second power stage based on the load condition. The multi-phase controller further includes a current-sense circuit coupled to receive a plurality of current-monitor signals from the plurality of power stages and configured to provide a summation signal to the current-mode regulation circuit based on the plurality of current-monitor signals, utilize a first current-monitor signal from the first power stage in place of a second current-monitor signal from the second power stage for a replacement period following a resumption of the second set of pulses to the second power stage.

This application claims the benefit of provisional patent application No. 63/717,600 , filed Nov. 7, 2024, which is hereby incorporated by reference herein in its entirety.

### TECHNICAL FIELD

The disclosure relates generally to multi-phase voltage regulator modules, and specifically to a system and method to facilitate entering and exiting ultra-light load mode for a multi-phase voltage regulator module.

### BACKGROUND

In the field of electronics, voltage regulator modules may be used to provide power to a processor included within a computing device such as a desktop computer, a laptop computer, a notebook computer, a tablet, or a smart phone. In recent years, government bodies around the world have placed, and continue to place, stringent rules and regulations regarding the power consumption of such devices. For example, according to Commission Regulation (EU) No. 617/2013, desktop and notebook computers must have a low-power state that can be activated automatically such as the Sleep State after fifteen minutes of inactivity or instantly by the end user. When connected to the mains, the power consumption in the low-power state should not exceed 0.5 W.

Due to such rules and regulations regarding power consumption of computing devices, system level designers of such computing devices may require the voltage regulator modules included therein to accommodate various sleep and low-power states. Further, the voltage regulator module must themselves remain efficient and consume little power during light load conditions. The inventors of various embodiments of the present disclosure have recognized that various components within a voltage regulator module may be disabled during light load conditions to reduce the power consumption of the voltage regulator module itself during light load conditions. Inventors of various embodiments of the present disclosure have also recognized that the disabling of certain components within a voltage regulator module may cause response time and/or stability issues when exiting a light load or an ultra-light load condition. Embodiments of the present disclosure may address one or more of these challenges.

### SUMMARY

The examples herein enable a multi-phase controller for a voltage regulator module that facilitates a fast and stable exit from light-load operation.

According to one embodiment, a multi-phase controller includes a current-mode regulation circuit configured to generate a PWM control signal based on a load condition of the voltage regulator module, a pulse distributor coupled to receive the PWM control signal from the current-mode regulation circuit and configured to (i) distribute pulses to a plurality of power stages, including a first set of pulses to a first power stage and a second set of pulses to a second power stage, and (ii) selectively enable or disable the second set of pulses to the second power stage based on the load condition of the voltage regulator module, and a current-sense circuit coupled to receive a plurality of current-monitor signals from the plurality of power stages and configured to (i) provide a summation signal to the current-mode regulation circuit based on the plurality of current-monitor signals, and (ii) utilize a first current-monitor signal from the first power stage in place of a second current-monitor signal from the second power stage for a replacement period following a resumption of the second set of pulses to the second power stage after a pulse-disable period. In some embodiments, the current-sense circuit is configured to resume use of the second current-monitor signal for generation of the summation signal after completion of the replacement period. In the same or different embodiments, the replacement period is in a range from 2.5 to 6.0 μs. In the same or different embodiments, the replacement period is programmable. In the same or different embodiments, the current-sense circuit is coupled to receive an N number of current-monitor signals from a corresponding N number of power stages, and wherein the N number is in a range from 2 to 48. In the same or different embodiments, the current-sense circuit includes a summation circuit configured to generate the summation signal based on a plurality of channel signals corresponding to the plurality of current-monitor signals, a first channel configured to provide a first channel signal to the summation circuit based on the first current-monitor signal from the first power stage, a second channel configured, when enabled, to provide a second channel signal to the summation circuit based on a selected one of the first current-monitor signal from the first power stage and the second current-monitor signal from the second power stage, and a redirection controller configured to (i) disable the second channel in response to a halting of the second set of pulses to the second power stage, (ii) enable the second channel in response to the resumption of the second set of pulses to the second power stage, (iii) instruct the second channel to select the first current-monitor signal for the replacement period that occurs after the resumption of the second set of pulses, and (iv) instruct the second channel to select the second current-monitor signal after an expiration of the replacement period. In the same or different embodiments, the redirection controller is configured to instruct the second channel to select the first current-monitor signal after a wait period following the halting of the second set of pulses to the second power stage. In the same or different embodiments, the first channel of the current-sense circuit includes a first resistor configured to convert the first current-monitor signal into a first voltage signal, and a first transconductance amplifier configured to provide the first channel signal to the summation circuit based on the first voltage signal, and the second channel of the current-sense circuit includes a second resistor configured to convert the second current-monitor signal into a second voltage signal, a multiplexor coupled to pass one of the first voltage signal and the second voltage signal in response to the redirection controller, and a second transconductance amplifier configured to provide the second channel signal to the summation circuit based on a multiplexor output.

According to another embodiment, a voltage regulator module includes a plurality of power stages, each including a high-side switching transistor, a low-side switching transistor, and a current-monitor circuit configured to provide a current-monitor signal representative of the total current through the high-side switching transistor and the low-side switching transistor. The voltage regulation module further includes a multi-phase controller including a current-mode regulation circuit configured to generate a PWM control signal based on a load condition of the voltage regulator module, a pulse distributor coupled to receive the PWM control signal from the current-mode regulation circuit and configured to (i) distribute pulses to a plurality of power stages, including a first set of pulses to a first power stage and a second set of pulses to a second power stage, and (ii) selectively enable or disable the second set of pulses to the second power stage based on the load condition of the voltage regulator module, and a current-sense circuit coupled to receive a plurality of current-monitor signals from the plurality of power stages and configured to (i) provide a summation signal to the current-mode regulation circuit based on the plurality of current-monitor signals, and (ii) utilize a first current-monitor signal from the first power stage in place of a second current-monitor signal from the second power stage for a replacement period following a resumption of the second set of pulses to the second power stage after a pulse-disable period. In some embodiments, the current-sense circuit is configured to resume use of the second current-monitor signal for generation of the summation signal after completion of the replacement period. In the same or different embodiments, the replacement period is in a range from 2.5 to 6.0 μs. In the same or different embodiments, the replacement period is programmable. In the same or different embodiments, the current-sense circuit is coupled to receive an N number of current-monitor signals from a corresponding N number of power stages, and wherein the N number is in a range from 2 to 48. In the same or different embodiments, the current-sense circuit includes a summation circuit configured to generate the summation signal based on a plurality of channel signals corresponding to the plurality of current-monitor signals, a first channel configured to provide a first channel signal to the summation circuit based on the first current-monitor signal from the first power stage, a second channel configured, when enabled, to provide a second channel signal to the summation circuit based on a selected one of the first current-monitor signal from the first power stage and the second current-monitor signal from the second power stage, and a redirection controller configured to (i) disable the second channel in response to a halting of the second set of pulses to the second power stage, (ii) enable the second channel in response to the resumption of the second set of pulses to the second power stage, (iii) instruct the second channel to select the first current-monitor signal for the replacement period that occurs after the resumption of the second set of pulses, and (iv) instruct the second channel to select the second current-monitor signal after an expiration of the replacement period. In the same or different embodiments, the redirection controller is configured to instruct the second channel to select the first current-monitor signal after a wait period following the halting of the second set of pulses to the second power stage. In the same or different embodiments, the current-monitor circuit of the second power stage is configured to enter a sleep state in response to the second power stage not receiving the second set of pulses for a delay period, and the wait period for instructing the second channel to select the first current-monitor signal is less than the delay period for the current-monitor circuit to enter the sleep state. In the same or different embodiments, the first channel of the current-sense circuit includes a first resistor configured to convert the first current-monitor signal into a first voltage signal, and a first transconductance amplifier configured to provide the first channel signal to the summation circuit based on the first voltage signal, and the second channel of the current-sense circuit includes a second resistor configured to convert the second current-monitor signal into a second voltage signal, a multiplexor coupled to pass one of the first voltage signal and the second voltage signal in response to the redirection controller, and a second transconductance amplifier configured to provide the second channel signal to the summation circuit based on a multiplexor output.

Another embodiment provides a method for controlling a multi-phase controller, wherein the method includes (i) generating a PWM control signal with a current-mode regulation circuit based on a load condition of the voltage regulator module, (ii) distributing pulses, based on the PWM control signal, to a plurality of power stages, including a first set of pulses to a first power stage and a second set of pulses to a second power stage, (iii) selectively enabling and disabling the second set of pulses to the second power stage based on the load condition of the voltage regulator module, (iv) receiving a plurality of current-monitor signals from the plurality of power stages, (v) generating a summation signal based on the plurality of current-monitor signals, (vi) utilizing a first current-monitor signal from the first power stage in place of a second current-monitor signal from the second power stage for generation of the summation signal for a replacement period in response to a resumption of the second set of pulses to the second power stage after a disable period for the second set of pulses, and (vii) providing the summation signal to the current-mode regulation circuit for regulation of the voltage regulator module. In some embodiments, the method further includes resuming use of the second current-monitor signal for the generation of the summation signal after the replacement period following the resumption of the second set of pulses to the second power stage. In the same or different embodiments, the replacement period is in a range from 2.5 to 6.0 μs.

### BRIEF DESCRIPTION OF THE DRAWINGS

A more complete understanding of the present embodiments may be acquired by referring to the following description taken in conjunction with the accompanying drawings, in which like reference numbers indicate like features.

FIG. 1 illustrates a top-level schematic diagram of a voltage regulator module (VRM) in accordance with embodiments of the present disclosure.

FIG. 2 illustrates a schematic diagram of a power stage in accordance with embodiments of the present disclosure.

FIG. 3 illustrates a schematic diagram of a multi-phase controller in accordance with embodiments of the present disclosure.

FIG. 4 illustrates a plot diagram of waveforms of a voltage regulator module in accordance with embodiments of the present disclosure.

FIG. 5 illustrates a schematic diagram of a current-sense circuit in accordance with embodiments of the present disclosure.

FIG. 6 illustrates a plot diagram of example system power states supported by a voltage regulator module in accordance with embodiments of the present disclosure.

FIG. 7 illustrates operating steps for a voltage regulator module in accordance with embodiments of the present disclosure.

FIG. 8 illustrates a method for operating a multi-phase controller in accordance with embodiments of the present disclosure.

### DETAILED DESCRIPTION

Details of one or more embodiments are set forth in the description below and the accompanying drawings. Other features will be apparent from the description, drawings, and from the claims. The embodiments disclosed should not be interpreted, or otherwise used, as limiting the scope of the disclosure, including the claims. In addition, one skilled in the art understands that the following description has broad application, and the discussion of any embodiment is meant to be exemplary of that embodiment, and not intended to intimate that the scope of the disclosure, including the claims, is limited to that embodiment.

Various terms are used to refer to particular system components. Different companies may refer to a component by different names, and this disclosure does not intend to distinguish between components that differ in name but not form and function. In the following discussion and in the claims, the terms “including” and “comprising” are used in an open-ended fashion, and thus should be interpreted to mean “including, but not limited to.” Also, the term “couple” or “coupled” is intended to encompass either an indirect connection or a direct connection. Thus, if a first device couples to, or is coupled to, a second device, that connection between the first device and the second device may be through a direct connection or through an indirect connection via other devices and connections.

Further, although the terms “first,” “second,” and so forth may be used herein to describe various elements, these elements should not be limited by these terms. Terms such as “first” and “second” may be used merely to distinguish one element from another. For example, a first element could be termed a second element, and, similarly, a second element could be termed a first element, without departing from the scope of the present disclosure. Further, the identification of a “first” element, does not necessarily require the presence of a “second” element. As used herein, the term “and/or” includes any and all combinations of one or more of the associated listed items.

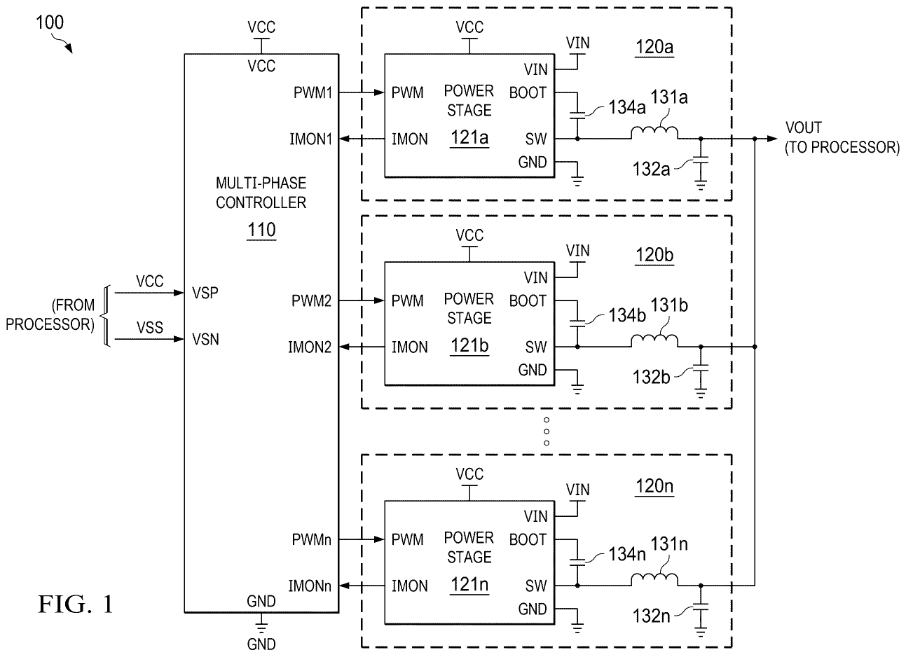

FIG. 1 illustrates a top-level schematic diagram of a voltage regulator module (VRM) 100 in accordance with embodiments of the present disclosure. VRM 100 may be implemented in any suitable fashion according to the operation described in the present disclosure. As shown in FIG. 1, VRM 100 may include multi-phase controller 110 and a plurality of buck-converter stages 120a-n. Each of the plurality of buck-converter stages 120a-n may convert the input voltage VIN into an output voltage VOUT to be supplied, for example, to the core of a processor in a computing system. In turn, multi-phase controller 110 may include a positive sense input VSP and a negative sense input VSN coupled to receive and thereby sense the output voltage directly at the rails of the core (VCC and VSS). Multi-phase controller 110 may also include a plurality of current-monitor (IMON) inputs to receive current information from each of the buck-converter stages 120a-n. Multi-phase controller 110 may control the pulse width and/or frequency of the PWM signals provided to the plurality of power stages 121a-n in order to drive VOUT to a desired voltage level at the given load current drawn by the processor.

For simplicity, multi-phase controller 110 is illustrated in FIG. 1 with various inputs and outputs most directly relevant to the functionality and improvements of the present disclosure. However, multi-phase controller 110 and the plurality of power stages 121a-n may include further inputs and outputs, for example to communicate with each other and with the processor. For example, multi-phase controller 110 may include further inputs, such as input to receive communications via I2C or SMBus to request telemetry information. As another example, multi-phase controller 110 may include further inputs to receive temperature information from one or more of the plurality of power stages 121a-n.

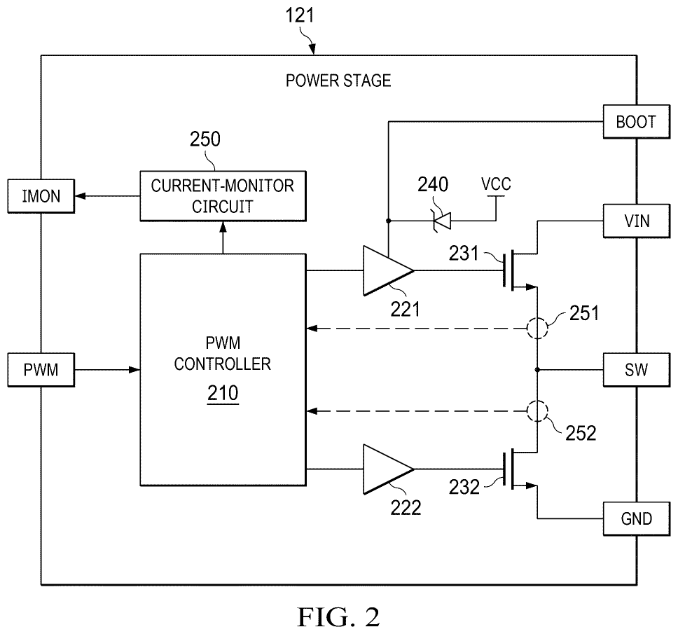

Buck-converter stages 120a-n may each include a respective one of the plurality of power stages 121a-n. As described in further detail below with reference to FIG. 2, each of the plurality of power stages 120a-n may include a high-side switching transistor coupled between the power supply input VIN and the switching node SW, and a low-side switching transistor coupled between the switching node SW and ground GND. The high-side switching transistor and the low-side switching transistor may be switched on and off (in an alternating fashion relative to each other) according to a respective PWM signal from multi-phase controller 110. As shown in FIG. 1, buck-converter stages 120a-n may each also include an LC filter coupled to the switching node SW of the respective power stage. For example, a first buck-converter stage 120a may include first power stage 121a coupled to inductor 131a and output capacitor 132a. A bootstrap capacitor 134a may be coupled between the switching node SW and the bootstrap node BOOT of first power stage 121a to power a high-side driver included therein. A second buck-converter stage 120b may similarly include second power stage 121b, inductor 131b, output capacitor 132b, and bootstrap capacitor 134b. In addition, an Nth buck-converter stage 120n may similarly include an Nth power stage 121n, inductor 131n, output capacitor 132n, and bootstrap capacitor 134n.

Although VRM 100 is illustrated in FIG. 1 with three buck-converter stages, VRM 100 may include any N number of buck-converter stages suitable for a given application. For example, VRM 100 may include 2, 4, 8, 16, 24, 48, or more buck-converter stages coupled to in parallel. Multi-phase controller 110 may in turn be configured to provide PWM signals for each of the respective buck-converter stages. In some embodiments, such as shown in FIG. 1, each buck-converter stage may be coupled in parallel to provide power to the same voltage rail (such as VOUT). In other embodiments, different groupings of one or more buck-converter stages may be coupled in parallel to provide power to multiple different power rails.

FIG. 2 illustrates a schematic diagram of power stage 121 in accordance with embodiments of the present disclosure. Power stage 121 may be implemented in any suitable fashion according to the operation described in the present disclosure. The schematic diagram for power stage 121 shown in FIG. 2 may represent an example schematic-level implementation for each of the plurality of power stages 121a-n described above with reference to FIG. 1.

As shown in FIG. 2, power stage 121 may include PWM controller 210, high-side driver 221, low-side driver 222, high-side switching transistor 231, and low-side switching transistor 232. PWM controller 210 may receive a PWM signal from multi-phase controller 110 via the PWM input of power stage 121. In response to the PWM signal, PWM controller 210 may control high-side driver 221 and low-side driver 222 to respectively turn on and off high-side switching transistor 231 and low-side switching transistor 232. For example, in response to a logic-high PWM signal, PWM controller 210 may force high-side switching transistor 231 to an on-state and low-side switching transistor 232 to an off-state. Conversely, in response to a logic-low PWM signal, PWM controller 210 may force high-side switching transistor 231 to an off-state and low-side switching transistor 232 to an on-state. In addition, PWM controller 210 may detect a high-impedance state (Hi-Z state) at the PWM input. In response to a Hi-Z state forced by multi-phase controller 110 at the PWM input of power stage 121, PWM controller 210 may force high-side switching transistor 231 to an off-state, and may also force low-side switching transistor 232 to an off-state after any recirculation current through the low-side switching transistor 232 during a preceding on-state of low-side switching transistor 232 reaches zero.

In some embodiments, high-side switching transistor 231 and low-side switching transistor 232 may each be implemented as n-type metal-oxide semiconductor field-effect transistors (referred to as n-type MOSFETs or NMOS transistors). To drive high-side switching transistor 231 in an on-state, high-side driver 221 may drive the gate of high-side switching transistor 231 at a voltage greater than VIN. As described above with reference to FIG. 1, a bootstrap capacitor may be coupled between the switching node SW and the bootstrap node BOOT of each power stage 121. And as shown in FIG. 2, power stage 121 may include diode 240 with an anode coupled to VIN and a cathode couped to the bootstrap node BOOT. The bootstrap capacitor and diode 240 may thus form a charge pump that may provide a voltage greater than VIN in response to the voltage at the SW node switching between GND and VIN. This voltage greater than VIN may in turn be used to provide power to high-side driver 221 such that high-side switching transistor 231 can be driven with a gate voltage greater than VIN when in an on-state.

Power stage 121 may also include high-side current sensor 251 and low-side current sensor 252. High-side current sensor 251 and low-side current sensor 252 may sense the respective currents through high-side switching transistor 231 and low-side switching transistor 232 without adding a resistive sensing element in the current path of the buck-converter stage in which power stage 121 is implemented. For example, in some embodiments, high-side current sensor 251 may be implemented by a high-side sense FET integrated with high-side switching transistor 231. Similarly, low-side current sensor 252 may be implemented by a low-side sense FET integrated with low-side switching transistor 232. PWM controller 210 may utilize the current sense information to control the on-state and/or off-state of high-side switching transistor 231 and low-side switching transistor 232. For example, when the PWM input is in a Hi-Z state as described above, PWM controller 210 may force low-side switching transistor 232 into an on-state until the low-side recirculation current reaches zero, at which time PWM controller 210 may force low-side switching transistor 232 into an off-state along with high-side switching transistor 231.

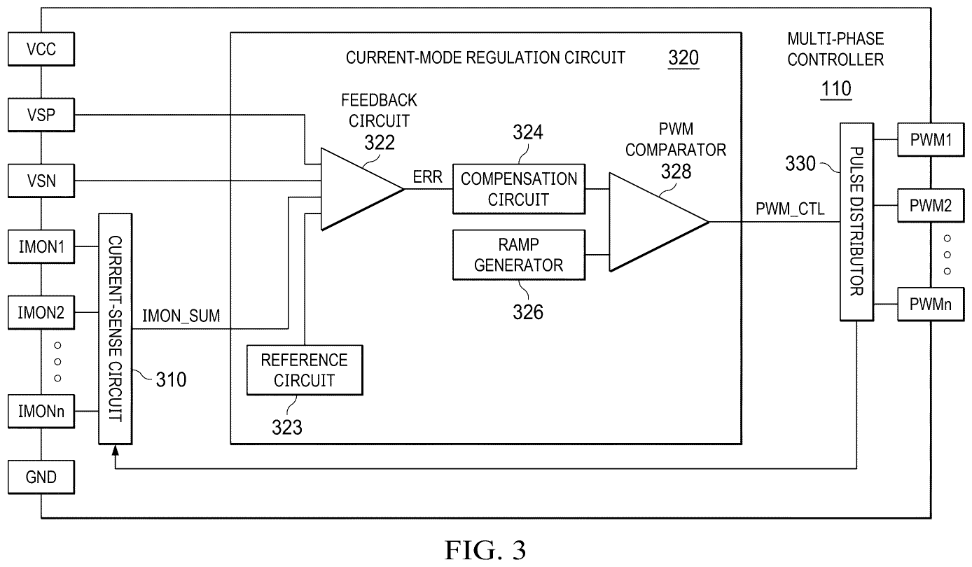

Power stage 121 may also include a current-monitor circuit 250 configured to provide a current-monitor signal IMON representative of the total current through the high-side switching transistor 231 and the low-side switching transistor 232. For example, current-monitor circuit 250 may aggregate the high-side current sense and the low-side current sense to generate a current-monitor signal IMON that is representative of the total current through both of high-side switching transistor 231 and low-side switching transistor 232 (and thereby representative of the output current for the respective buck-converter stage in which power stage 121 is implemented). In some embodiments, the current-monitor signal IMON may be provided, for example, at a level of 5 μA per amp of current measured through high-side switching transistor 231 and low-side switching transistor 232. As shown in FIG. 1, each of the plurality of power stages 121a-n may provide a respective current-monitor signal IMON to multi-phase controller 110. And as described below with reference to FIG. 3, multi-phase controller 110 may utilize a sum of the respective current-monitor signals (IMON1, IMON2, through IMONn) to detect the overall load current and to control the respective PWM signals to the plurality of power stages 121a-n accordingly.

FIG. 3 illustrates a schematic diagram of multi-phase controller 110 in accordance with embodiments of the present disclosure. Multi-phase controller 110 may be implemented in any suitable fashion according to the operation described in the present disclosure. The schematic diagram shown in FIG. 3 may represent an example schematic-level implementation for the multi-phase controller 110 described above with reference to FIG. 1.

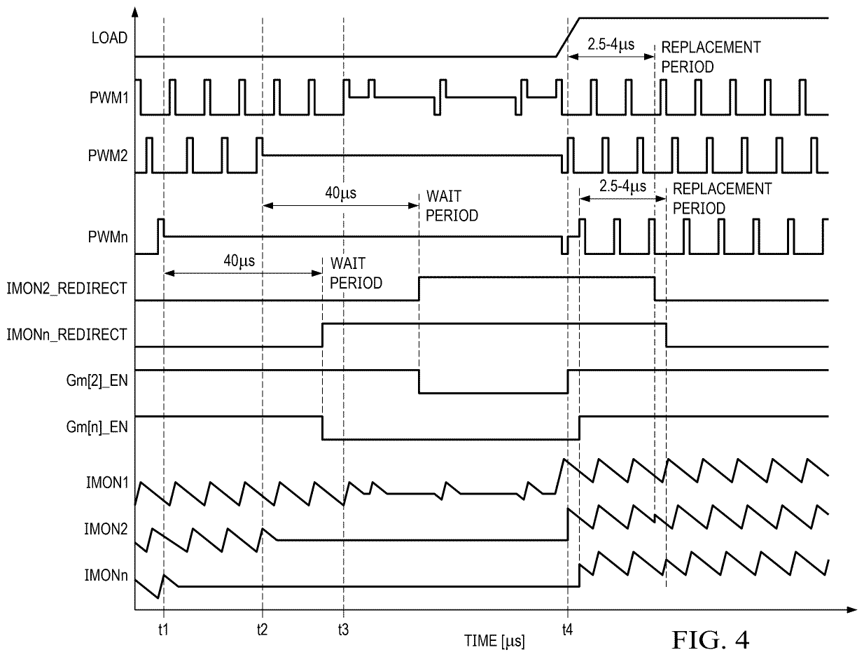

As shown in FIG. 3, multi-phase controller 110 may include current-sense circuit 310, current-mode regulation circuit 320, and pulse distributor 330. Current-sense circuit 310 may be coupled to receive a plurality of current-monitor signals (IMON1, IMON2, through IMONn) from the plurality to power stages 121a-n (shown in FIG. 1). As described in further detail below with reference to FIG. 4, current-sense circuit 310 may be configured to provide a summation signal IMON_SUM to current-mode regulation circuit 320 based on the plurality of current-monitor signals (IMON1, IMON2, through IMONn).

Current-mode regulation circuit 320 may be configured to generate a PWM control signal PWM_CTL based on a load condition of VRM 100. Specifically, current-mode regulation circuit 320 may implement a current-mode feedback loop to control the pulse-width and/or frequency of the PWM signals sent to the respective power stages 121a-n based on both voltage feedback and current feedback. In some embodiments, current-mode regulation circuit 320 may include feedback circuit 322, reference circuit 323, compensation circuit 324, ramp generator 326, and PWM comparator 328. Reference circuit 323 may provide a reference voltage representative of the desired output voltage for VRM 100. Feedback circuit 322 may compare a differential output voltage (as sensed directly at the processor via VSP and VSN) against the reference voltage to generate an error signal ERR that is scaled in part based on the summation signal IMON_SUM that represents the sum of the current through each respective buck-converter stage 120a-n (and thus represents the load current drawn by the processor).

As shown in FIG. 3, current-mode regulation circuit 320 may include a compensation circuit 324 to shape the frequency response to feedback circuit 322, and to thereby stabilize the current-mode control loop implemented by current-mode regulation circuit 320. As described in further detail below, various embodiments included herein may be utilized to maintain current-mode control (as opposed to reverting to voltage mode control) even under extreme conditions such as coming out of an ultra-light load condition. Accordingly, compensation circuit 324 may be implemented with a simple proportional-integral (PI) compensation scheme as opposed to a more complex proportional-integral-differential (PID) compensation scheme that may otherwise be required to maintain loop stability if multi-phase controller 110 reverted to voltage-mode control under certain conditions such as exiting ultra-light load.

PWM comparator 328 may compare the compensated error signal against a ramp signal from ramp generator 326. Based on this comparison, PWM comparator may generate a PWM control signal PWM_CTL for controlling, at least in part, the pulse width and/or frequency of pulses to be distributed to the plurality of power stages 121a-n by pulse distributor 330. Ramp generator 326 may vary the amplitude and/or the frequency of the ramp signal provided to PWM comparator 328 to vary the PWM_CTL signal under various load conditions based on a number of factors, including but not limited to the input voltage VIN, the desired output voltage VOUT, and the number of phases (the number of buck-converter stages) of VRM 100 that are active at a given time.

As shown in FIG. 3, pulse distributor 330 may be coupled to receive the PWM control signal PWM_CTL from current-mode regulation circuit 320. Pulse distributor 330 may be configured to distribute pulses to the plurality of power stages 121a-n, including for example a first set of pulses to first power stage 121a (via PWM1), a second set of pulses to second power stage 121b (via PWM2), and in some embodiments an Nth set of pulses to an Nth power stage 121n (via PWMn).

FIG. 4 illustrates a plot diagram of example waveforms of VRM 100 in accordance with embodiments of the present disclosure. Specifically, FIG. 4 illustrates a plot diagram for an example embodiment of VRM 100 whereby N=3, that is VRM 100 includes three buck-converter stages driven by three PWM signals (PWM1, PWM2, and PWMn).

The three PWM signals PWM1, PWM2, and PWMn, may be interleaved relative to each other during normal load conditions, as shown for example after time t4 in FIG. 4. The interleaving of the PWM pulses for the different buck-converter stages may allow VRM 100 to provide a more stable output voltage VOUT to the processor load with less ripple at moderate to heavy load currents compared to a similar single-phase buck converter. Nonetheless, during light load conditions that may induce less ripple, the switching for PWM1, PWM2, and PWMn may be controlled to improve efficiency.

During light load conditions (for example, when the processor load is in a sleep state), one or more phases of VRM 100 may be disabled to reduce current consumption of VRM 100 itself, and to thereby improve light load efficiency. For example, as shown in FIG. 4, PWMn may be placed in a Hi-Z state at time t1 to disable switching of Nth power stage 121n. For the purposes of the present disclosure, the Hi-Z state may be represented in FIG. 4 as a medium level between the logic-high level and the logic-low level of the pulses shown for PWM1, PWM2, and PWMn. As described above with reference to FIG. 2, placing PWMn in a Hi-Z state may force power stage 121n to place both the high-side switching transistor and the low-side switching transistor included therein in respective off-states. By disabling switching, the power that would otherwise be consumed to charge and discharge the gates of those transistors may be saved. Continuing to time t2 in FIG. 4, PWM2 may also be placed in a Hi-Z state to disable switching of the second power stage 121b to further save power and increase light-load efficiency. Subsequently at time t3, PWM1 may continue switching low and high, but at a lower frequency. The continued switching of first power stage 121a as driven by PWM1 may ensure continued operation of the regulation loop of VRM 100, as well as ensuring that bootstrap capacitor 134a (shown in FIG. 1) is refreshed and remains sufficiently charged to power the high-side driver 221 within first power stage 121a. Further, the lower frequency of PWM1 may reduce the switching losses associated with turning off and on the high-side switching transistor and low-side switching transistor of the first power stage 121a. Thus, the lower frequency of PWM1 between time t3 and time t4 may further improve the light-load efficiency of VRM 100 while still maintaining regulation of VOUT.

In addition to the power savings described above, further power savings may be achieved by disabling certain circuitry within second power stage 121b through Nth power stage 121n when the PWM pulses for those respective power stages are halted. As described above with reference to FIG. 3, pulse distributor 330 may be configured to distribute pulses to the plurality of power stages 121a-n, including for example a first set of pulses to first power stage 121a (via PWM1), a second set of pulses to second power stage 121b (via PWM2), and in some embodiments an Nth set of pulses to an Nth power stage 121n (via PWMn). Second power stage 121b may be configured such that the current-monitor circuit 250 of second power stage 121b enters a sleep state in response to second power stage 121b not receiving the second set of pulses for a delay period. Similarly, Nth power stage 121n may be configured such that the current-monitor circuit 250 of Nth power stage 121n enters a sleep state in response to Nth power stage 121n not receiving the Nth set of pulses for a delay period. In some embodiments, the delay period for the current-monitor circuit 250 may be, for example, 50 μs.

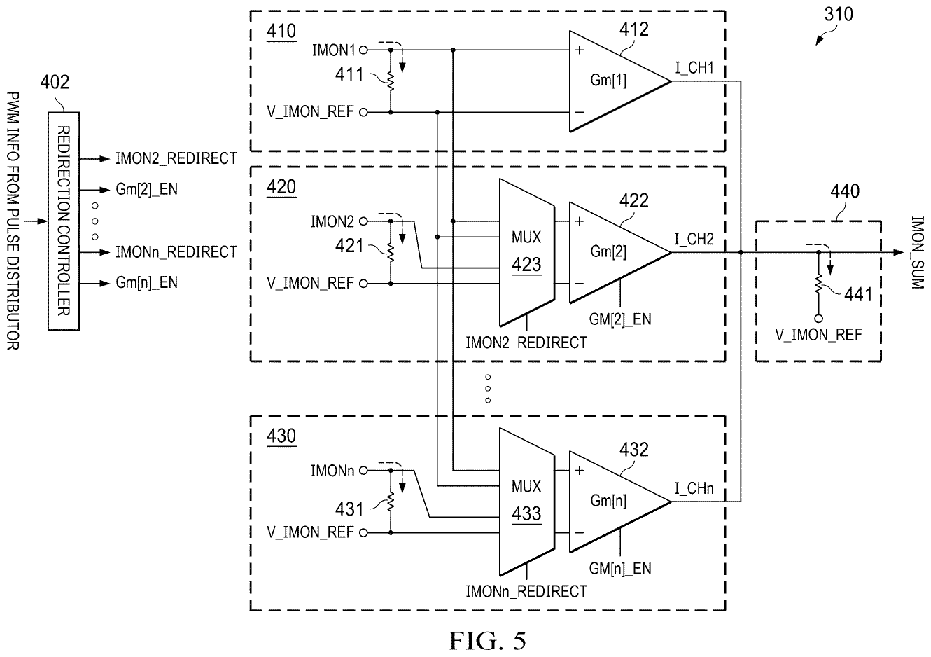

When exiting the light load condition, the previously disabled phases of VRM 100 resume switching. For example, as shown in FIG. 4, the load may increase at time t4, after which time the second set of pulses (via PWM2) and the Nth set of pulses (via PMWn) may resume. Upon resumption of the second set of pulses, the current-monitor circuit 250 within second power stage 121b may wake up and resume normal operation. Similarly, upon resumption of the Nth set of pulses, the current-monitor circuit 250 within Nth power stage 121n may wake up and resume normal operation. In some embodiments, the wake-up time for current-monitor circuit 250 may be, for example, between 2.5 and 6.0 μs. In some such embodiments, the wake-up time for current-monitor circuit 250 may be, for example, between 2.5 and 4.0 μs. During this wake-up time, the second current-monitor signal (IMON2) and the Nth current-monitor signal (IMON3) may not accurately reflect the current flowing in second power stage 121b and Nth power stage 121n. As described below with reference to FIG. 5, current-sense circuit 310 may be configured to replace this invalid current-monitor information during the wake-up time in order to maintain stable current-mode regulation when VRM 100 exits a light-load condition.

FIG. 5 illustrates a schematic diagram of current-sense circuit 310 in accordance with embodiments of the present disclosure. Current-sense circuit 310 may be implemented in any suitable fashion according to the operation described in the present disclosure. The schematic diagram shown in FIG. 5 may represent an example schematic-level implementation for the current-sense circuit 310 described above with reference to FIG. 3. As shown in FIG. 5, current-sense circuit 310 may include redirection controller 402, first channel 410, second channel 420, Nth channel 430, and summation circuit 440. Although illustrated with three channels, current-sense circuit 310 may include any suitable N number of channels to correspond to the N number of current-monitor signals (IMON) from an N number of power stages. For example, current-sense circuit 310 may be coupled to receive an N number of current-monitor signal from a corresponding N number of power stages, where the N number is in a range from 2 to 48.

During normal load conditions when each of the plurality of power stages 121a-n are switching, current-sense circuit 310 may add the various current monitor signals (IMON1, IMON2, through IMONn) from the plurality of power stages 121a-n to provide a summation signal representing the total load current to current-mode regulation circuit 320. But, as described above, the second current-monitor signal (IMON2) and the Nth current-monitor signal (IMON3) may not accurately reflect the current flowing in second power stage 121b and Nth power stage 121n when VRM 100 is coming out of a light-load condition and the current-monitor circuits 250 of second power stage 121b and Nth power stage 121n are still waking up from a sleep state. In the absence of current-monitor information from second power stage 121b and Nth power stage 121n while the respective instances of current-monitor circuit 250 in those power stages are waking up, the regulation loop may more closely resemble a voltage-mode regulation loop as opposed to the designed current-mode regulation. Such voltage-mode operation would require a more complex compensation circuit 324 (for example a PID compensation) than otherwise required for current-mode regulation. To save the cost of such a more complex compensation scheme, current-sense circuit 310 may be configured to replace this invalid current-monitor information during the wake-up time in order to maintain stable current-mode regulation when VRM 100 exits a light-load condition.

As described in further detail below, current-sense circuit 310 may utilize the first current-monitor signal IMON1 from the first power stage 121a in place of a second-current monitor signal IMON2 from the second power stage 121b for a replacement period following resumption of the second set of pulses (via PWM2) after a pulse-disable period for PWM2. Current-sense circuit 310 may also be configured to resume use of the second current-monitor signal IMON2 for generation of the summation signal IMON_SUM after completion of the replacement period for IMON2. Similarly, current-sense circuit 310 may utilize the first current-monitor signal IMON1 from the first power stage 121a in place of an Nth-current monitor signal IMONn from the Nth power stage 121n for a replacement period following resumption of the Nth set of pulses (via PWMn) after a pulse-disable period for PWMn. Further, current-sense circuit 310 may be configured to resume use of the Nth current-monitor signal IMONn for generation of the summation signal IMON_SUM after completion of that replacement period for IMONn.

As shown in FIG. 5, first channel 410 of current-sense circuit 310 may be configured to provide a first channel signal I_CH1 (in the form of a current) to summation circuit 440 based on the first-current monitor signal IMON1 from first power stage 121a. In some embodiments, first channel 410 of current-sense circuit 310 may include a first resistor 411 and a first transconductance amplifier 412. First resistor 411 may be coupled between the IMON1 input and a voltage reference V_IMON_REF, and may thus be configured to convert the first current-monitor signal IMON (in the form of a current) into a first voltage signal. The first voltage signal may be applied across the inputs of first transconductance amplifier 412, which may be configured to output the first channel signal I_CH1 based on the first voltage signal.

As further shown in FIG. 5, second channel 420 may be configured, when enabled, to provide a second channel signal I_CH2 (in the form of a current) to summation circuit 440 based on a selected one of the first current monitor signal IMON1 from first power stage 121a and the second current-monitor signal IMON2 from second power stage 121b. For example, second channel 420 of current-sense circuit 310 may include a second resistor 421, multiplexor 423, and second transconductance amplifier 422. Second resistor 421 may be coupled between the IMON2 input and V_IMON_REF and may thus be configured to convert the second current-monitor signal IMON2 (in the form of a current) into a second voltage signal. Multiplexor 423 may be coupled to pass one of the first voltage signal (based on IMON1) and the second voltage signal (based on IMON2) in response to redirection controller 402. Further, second transconductance amplifier 422 may be configured to provide the second channel signal I_CH2 to summation circuit 440 based on the multiplexor output of multiplexor 423.

In addition, Nth channel 430 may be configured, when enabled, to provide an Nth channel signal I_CHn (in the form of a current) to summation circuit 440 based on a selected one of the first current monitor signal IMON1 from first power stage 121a and the Nth current-monitor signal IMONn from Nth power stage 121n. For example, Nth channel 430 of current-sense circuit 310 may include an Nth resistor 431, multiplexor 433, and Nth transconductance amplifier 432. Nth resistor 431 may be coupled between the IMONn input and V_IMON_REF and may thus be configured to convert the Nth current-monitor signal IMONn (in the form of a current) into an Nth voltage signal. Multiplexor 433 may be coupled to pass one of the first voltage signal (based on IMON1) and the Nth voltage signal (based on IMONn) in response to redirection controller 402. Further, Nth transconductance amplifier 432 may be configured to provide the Nth channel signal I_CHn to summation circuit 440 based on the multiplexor output of multiplexor 433.

Summation circuit 440 may be configured to generate the summation signal IMON_SUM based on the plurality of channel signals (ICH_1, ICH_2, through I_CHn) corresponding to the plurality of current-monitor signals (IMON1, IMON2, IMONn). In some embodiments, summation circuit 440 may be implemented with a summation resistor 441 configured to receive each of the plurality of channel signals (ICH_1, ICH_2, through I_CHn) in the form of currents. The summation resistor 441 may thus develop a voltage drop proportional to the sum of the plurality of channel signals (ICH_1, ICH_2, through I_CHn). Accordingly, the summation signal IMON_SUM may thus be developed by summation resistor 441 and passed to current-mode regulation circuit 320 as shown in FIG. 3.

Redirection controller 402 may be configured to both enable and disable the second channel 420 through the Nth channel 430, as well as to control the selection made by multiplexors 423 and multiplexor 433 respectively included therein. For example, redirection controller 402 may receive PWM information from pulse distributor 330, indicating the status of each of PWM1, PWM2, through PWMn. Redirection controller 402 may in turn be configured to enable or disable the second channel 420 through the Nth channel 430, as well as to control the selection made by multiplexors 423 and multiplexor 433, based on whether the pulse distributor 330 is actively providing, has halted, or has resumed, pulses to second power stage 121b (via PWM2) through the Nth power stage 121n (via PWMn).

Referring back to FIG. 4, the second set of pulses provided to second power stage 121b(via PWM2) may be halted at time t2. Redirection controller 402 may be configured to disable the second channel 420 of current-sense circuit 310 in response to the halting of the second set of pulses to the second power stage 121b. For example, redirection controller 402 may de-assert the Gm[2]_EN enable signal for second transconductance amplifier 422 after a wait period following the halting of the second set of pulses (via PWM2) to the second power stage 121b at time t2. When disabled, the power consumption of second transconductance amplifier 422 may be reduced or eliminated. Accordingly, further power savings may be realized by the disabling of second transconductance amplifier 422 after the wait period following the halting of the second set of pulses (via PWM2) to the second power stage 121b at time t2.

Redirection controller 402 may further be configured to instruct the second channel 420 to enable (or re-enable) the second channel 420 in response to the resumption of the second set of pulses (via PWM2) to the second power stage 121b. For example, the second set of pulses (via PWM2) may resume after time t4, as the load current increases and VRM 100 exits the light load condition. In response to the resumption of the second set of pulses (via PWM2) to the second power stage 121b, redirection controller 402 may assert (or re-assert) the Gm[2]_EN enable signal for second transconductance amplifier 422. Accordingly, current-sense circuit 310 may include IMON2 (or the replacement of IMON1 in place of IMON2 during the replacement period) in the generation of the summation signal IMON_SUM after resumption of the second set of pulses (via PWM2) to the second power stage 121b.

Redirection controller 402 may also instruct the second channel 420 to select the first current-monitor signal for the replacement period that occurs after the resumption of the second set of pulses to second power stage 121b (via PWM2). For example, redirection controller 402 may assert the IMON2_REDIRECT signal to instruct the multiplexor 423 to pass the first voltage signal (based on IMON1) to second transconductance amplifier 422 at least during the replacement period following the resumption of the second set of pulses to second power stage 121b (via PWM2). As shown in FIG. 4, redirection controller 402 may be configured to instruct the second channel 420 to select the first current-monitor signal IMON1 after a wait period following the halting of the second set of pulses to the second power stage 121b. In some embodiments, the wait period for instructing the second channel 420 to select the first current-monitor signal IMON1 may be less than the delay period for the current-monitor circuit 250 of second power stage 121b to enter the sleep state. Accordingly, the second channel 420 may be ready to use first current-monitor signal IMON1 in place of the second current-monitor signal IMON2 any time that current-monitor circuit 250 begins to wake-up after the resumption of the second set of pulses (via PWM2) to second power stage 121b.

Further, redirection controller 402 may instruct the second channel 420 to select the second current-monitor signal IMON2 after the expiration of the replacement period. For example, after expiration of the replacement period, redirection controller 402 may de-assert the IMON2_REDIRECT signal to instruct multiplexor 423 to pass the second voltage signal (based on IMON2) to second transconductance amplifier 422. In some embodiments, the replacement period may be in a range from 2.5 to 6.0 μs. In some embodiments, the replacement period may be in a range from 2.5 to 4.0 μs. This replacement period may be programmable, for example in 0.5 μs increments between 2.5 and 4.0 μs or in 0.5 μs increments between 2.5 and 6.0 μs. The replacement period may be programmed to correspond to the expected wake-up time for the current-monitor circuit 250 in second power stage 121b. Accordingly, current-sense circuit 310 may resume use of the second current-monitor signal IMON2 to generate the summation signal IMON_SUM when that current-monitor circuit 250 is awake and the second current-monitor signal IMON2 is valid.

As shown in FIG. 5, the Nth channel 430 may be configured in a similar manner as the second channel 420. Redirection controller 402 may accordingly assert and de-assert the Gm[n]_EN enable signal and the IMONn_REDIRECT signal to control the Nth channel 430 in response to the halting and the resumption of the Nth set of pulses (via PWMn) sent to Nth power stage 121n in a similar manner as described above for second channel 420. Further channels between the second channel 420 and the Nth channel 430 may also operate in a similar manner as described above for second channel 420.

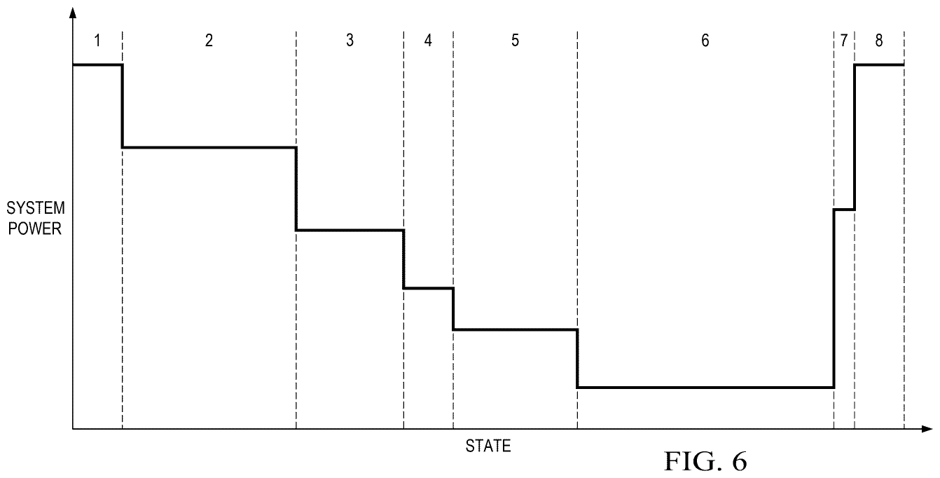

FIG. 6 illustrates a plot diagram of example system power states supported by VRM 100 in accordance with embodiments of the present disclosure.

In State 1, all blocks of VRM 100 may be in an active state. For example, all blocks within multi-phase controller 110 (including second transconductance amplifier 422 and Nth transconductance amplifier 432) and all blocks within the plurality of power stages 121a-n (including the respective instances of current-monitor circuit 250) may be enabled and active.

In State 2, the Nth set of pulses (via PWMn) may be halted. For example, as shown at time t1 in FIG. 4, PWMn may be placed in a Hi-Z state, thereby halting the switching of the high-side switching transistor 231 and the low-side switching transistor 232 of Nth power stage 121n. The switching loss that would otherwise be incurred due to the power consumed by driving the gates of the high-side switching transistor 231 and the low-side switching transistor 232 of Nth power stage 121n is saved, therefore reducing the power consumption of Nth power stage 121n. Accordingly, the power consumption of the system as a whole is reduced relative to State 1.

In State 3, the second set of pulses (via PWM2) may be halted. For example, as shown at time t2 in FIG. 4, PWM2 may be placed in a Hi-Z state, thereby halting the switching of the high-side switching transistor 231 and the low-side switching transistor 232 of second power stage 121b. The switching loss that would otherwise be incurred due to the power consumed by driving the gates of high-side switching transistor 231 and low-side switching transistor 232 of second power stage 121b is therefore saved, reducing the power consumption of second power stage 121b. Accordingly, the power consumption of the system as a whole is further reduced.

In State 4, the Nth transconductance amplifier 432 may be disabled to save power that would otherwise be consumed by the Nth transconductance amplifier 432 when enabled. For example, as shown in FIG. 4, the GM[n]_EN signal may be forced low to disable Nth transconductance amplifier 432 at a wait time of 40 μs after time t1 when PWMn was halted. In addition, the current-monitor circuit 250 in Nth power stage 121n may be placed in a sleep state to save quiescent current consumption. Accordingly, the power consumption of the system as a whole is further reduced.

In state 5, the first set of pulses (via PWM1) may exit fixed frequency operation and may enter a variable frequency operation. For example, as shown in FIG. 4 at time t3, the first set of pulses (via PWM1) may have a lower frequency dependent on the load. During the fixed frequency operation (prior to time t3), the first buck-converter stage 120a may operate in a continuous conduction mode (CCM). During the variable frequency operation (immediately following time t3), the first buck-converter stage 120a may operate in a discontinuous conduction mode, only switching when necessary to support the light load and/or to refresh bootstrap capacitor 134 a. Thus, the frequency may be reduced, for example from 600 kHz to 25 kHz during light load conditions. Accordingly, the switching losses of first power stage 121a may be reduced, further reducing the power consumption of the system as a whole.

In State 6, the second transconductance amplifier 422 may be disabled to save power that would otherwise be consumed by the second transconductance amplifier 422 when enabled. For example, as shown in FIG. 4, the GM[2]_EN signal may be forced low to disable the second transconductance amplifier 422 at a wait time of 40 μs after time t2 when PWM2 was halted. In addition, the current-monitor circuit 250 in second power stage 121b may be placed in a sleep state to save quiescent current consumption. Accordingly, the power consumption of the system as a whole is further reduced.

Prior to State 7 and State 8, a large load event may occur. For example, multi-phase controller 110 may detect a drop in the feedback voltage resulting from a sudden increase of the load current. Multi-phase controller 110 may thus resume the second set of pulses (via PWM2) and the Nth set of pulses (via PWMn) in State 7 and State 8.

In State 7, and as shown after time t4 in FIG. 4, the second set of pulses (via PWM2) may resume and the Gm[2]_EN signal may be re-asserted to enable second transconductance amplifier 422. Further, the current-monitor circuit 250 in second power stage 121b may wake up in response to the resumption of the second set of pulses (via PWM2).

In State 8, and as shown after time t4 in FIG. 4, the Nth set of pulses (via PWMn) may resume and the Gm[n]_EN signal may be re-asserted to enable Nth transconductance amplifier 432. Further, the current-monitor circuit 250 in Nth power stage 121n may wake up in response to the resumption of the Nth set of pulses (via PWMn).

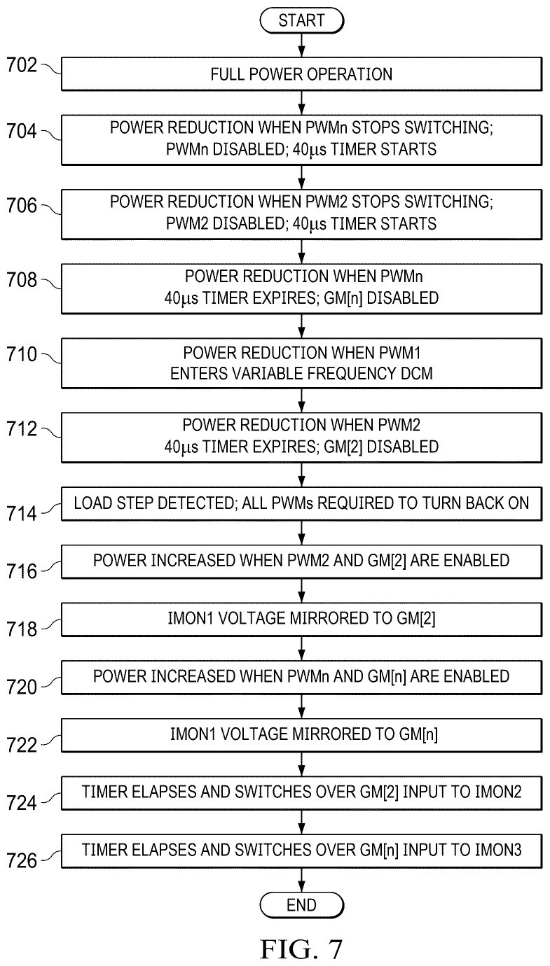

FIG. 7 illustrates operating steps for VRM 100 in accordance with embodiments of the present disclosure.

At step 702, VRM 100 may operate in full power operation. As described above for State 1, all blocks of VRM 100 may be in an active state.

At step 704, the power consumption of VRM 100 may be reduced by shedding an Nth phase. For example, as described above or State 2, the Nth set of pulses (via PWMn) may be halted. As shown at time t1 in FIG. 4, PWMn may be placed in a Hi-Z state, thereby halting the switching of Nth power stage 121n, eliminating the associated switching loss and therefore reducing power consumption of VRM 100. Further, a timer within redirection controller 402 may begin counting a wait time, for example 40 μs, for disabling the Nth transconductance amplifier 432.

At step 706, the power consumption of VRM 100 may be further reduced by shedding the second phase. For example, as described above or State 3, the second set of pulses (via PWM2) may be halted. As shown at time t2 in FIG. 4, PWM2 may be placed in a Hi-Z state, thereby halting the switching of second power stage 121b, eliminating the associated switching loss and therefore reducing power consumption of VRM 100. Further, a timer within redirection controller 402 may begin counting a wait time, for example 40 μs, for disabling the second transconductance amplifier 422.

At step 708, the power consumption of VRM 100 may be further reduced when the wait time for disabling the Nth transconductance amplifier 432 expires. For example, as shown in FIG. 4, the GM[n]_EN signal may be forced low to disable Nth transconductance amplifier 432 at a wait time of 40 μs after time t1 when PWMn was halted.

At step 710, the power consumption of VRM 100 may be further reduced when the first phase enters a variable-frequency discontinuous conduction mode (DCM). During the variable frequency operation (illustrated in FIG. 4 immediately following time t3), the first buck-converter stage 120a may operate in a discontinuous conduction mode, only switching when necessary to support the light load and/or to refresh bootstrap capacitor 134a. Accordingly, the switching losses of first power stage 121a may be reduced, further reducing the power consumption of VRM 100 as a whole.

At step 712, the power consumption of VRM 100 may be further reduced when the wait time for disabling the second transconductance amplifier 422 expires. For example, as shown in FIG. 4, the GM[2]_EN signal may be forced low to disable second transconductance amplifier 422 at a wait time of 40 μs after time t2 when PWM2 was halted.

At step 714, a load step may be detected. For example, multi-phase controller 110 may detect a drop in the feedback voltage resulting from a sudden increase of the load current. Multi-phase controller 110 may thus resume the second set of pulses (via PWM2) and the Nth set of pulses (via PWMn) as described below.

At step 716, the second set of pulses (via PWM2) may resume and the Gm[2]_EN signal may be re-asserted to re-enable second transconductance amplifier 422. Further, the current-monitor circuit 250 in second power stage 121b may wake up in response to the resumption of the second set of pulses (via PWM2).

At step 718, current-sense circuit 310 may utilize IMON1 in place of IMON2 for generating the summation current. For example, redirection controller 402 may continue to assert the IMON2_REDIRECT signal to force multiplexor 423 to select and pass the first voltage (based on IMON1 through first resistor 411) in place of the second voltage (based on IMON2 through second resistor 421) for a replacement period of 2.5 to 4.0 μs after the resumption of the second set of pulses (via PWM2).

At step 720, the Nth set of pulses (via PWMn) may resume and the Gm[n]_EN signal may be re-asserted to re-enable Nth transconductance amplifier 432. Further, the current-monitor circuit 250 in Nth power stage 121n may wake up in response to the resumption of the Nth set of pulses (via PWMn).

At step 722, current-sense circuit 310 may utilize IMON1 in place of IMONn for generating the summation current. For example, redirection controller 402 may continue to assert the IMONn_REDIRECT signal to force multiplexor 433 to select and pass the first voltage (based on IMON1 through first resistor 411) in place of an Nth voltage (based on IMONn through Nth resistor 431) for a replacement period of 2.5 to 4.0 μs after the resumption of the Nth set of pulses (via PWMn).

At step 724, the replacement period for IMON2 may expire. As shown in FIG. 4, after the replacement period for IMON2 expires, redirection controller 402 may de-assert the IMON2_REDIRECT signal to force multiplexor 423 to select and pass the second voltage (based on IMON2 through second resistor 421).

At step 726, the replacement period for IMONn may expire. As shown in FIG. 4, after the replacement period for IMONn expires, redirection controller 402 may de-assert the IMONn_REDIRECT signal to force multiplexor 433 to select and pass the Nth voltage (based on IMONn through Nth resistor 431).

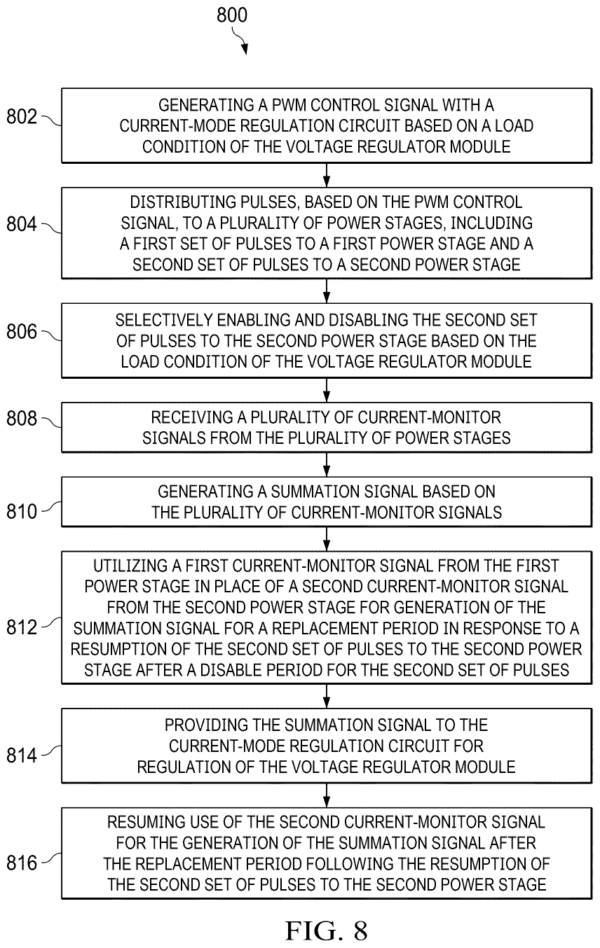

FIG. 8 illustrates a method 800 for operating a multi-phase controller in accordance with embodiments of the present disclosure. Method 800 may be performed by any suitable mechanism, such as multi-phase controller 110. Method 800 may be performed with fewer or more steps than shown in FIG. 8. Moreover, steps of method 800 may be omitted, repeated, performed in parallel, performed in a different order than shown in FIG. 8, or performed recursively. One or more steps of method 800, although shown in an order, may be performed at the same time or in a re-ordered manner.

Step 802 may include generating a PWM control signal with a current-mode regulation circuit based on a load condition of the voltage regulator module. For example, as described above with reference to FIG. 3, current-mode regulation circuit 320 may be configured to generate a PWM control signal PWM_CTL based on a load condition of VRM 100. Specifically, current-mode regulation circuit 320 may implement a current-mode feedback loop to control the pulse-width and/or frequency of the PWM signals sent to the respective power stages 121a-n based on both voltage feedback and current feedback.

Step 804 may include distributing pulses, based on the PWM control signal, to a plurality of power stages, including a first set of pulses to a first power stage and a second set of pulses to a second power stage. For example, as described above with reference to FIG. 3, pulse distributor 330 of multi-phase controller 110 may be coupled to receive the PWM control signal PWM_CTL from current-mode regulation circuit 320. Pulse distributor 330 may be configured to distribute pulses to the plurality of power stages 121a-n, including for example a first set of pulses to first power stage 121a (via PWM1), a second set of pulses to second power stage 121b (via PWM2), and in some embodiments an Nth set of pulses to an Nth power stage 121n (via PWMn).

Step 806 may include selectively enabling and disabling the second set of pulses to the second power stage based on the load condition of the voltage regulator module. For example, as shown in FIG. 4, the second set of pulses (via PWM2) provided to second power stage 121b may be halted at time t2 during a light load condition and then resumed after time t4 when the load increases.

Step 808 may include receiving a plurality of current-monitor signals from the plurality of power stages. For example, as collectively shown in FIG. 1 and FIG. 3, current-sense circuit 310 may receive a plurality of current-monitor signals (IMON1, IMON2, through IMONn) from the plurality of power stages (including first power stage 121a, second power stage 121b, and Nth power stage 121n).

Step 810 may include generating a summation signal based on the plurality of current-monitor signals. For example, as described above with reference to FIG. 3, current-sense circuit 310 may generate a summation signal IMON_SUM based on the plurality of current-monitor signals (including IMON1, IMON2, through IMONn).

Step 812 may include utilizing a first current-monitor signal from the first power stage in place of a second current-monitor signal from the second power stage for generation of the summation signal for a replacement period in response to a resumption of the second set of pulses to the second power stage after a disable period for the second set of pulses. For example, as described above with reference to FIG. 3 and FIG. 4, current-sense circuit 310 may utilize the first current-monitor signal IMON1 from first power stage 121a in place of the second current-monitor signal IMON2 from second power stage 121b for a replacement period in response to a resumption of the second set of pulses (via PWM2) to second power stage 121b after a period of time whereby the second set of pulses were disabled.

Step 814 may include providing the summation signal to the current-mode regulation circuit for regulation of the voltage regulator module. For example, as shown in FIG. 3, current-sense circuit 310 may provide the summation signal IMON_SUM to feedback circuit 322 within current-mode regulation circuit 320. In turn, current-mode regulation circuit 320 may use the summation signal IMON_SUM as an indication of the total load current to thereby regulate the output voltage VOUT of VRM 100 using current-mode regulation.

Step 816 may include resuming use of the second current-monitor signal for the generation of the summation signal after the replacement period following the resumption of the second set of pulses to the second power stage. For example, as described above with reference to FIG. 4, redirection controller 402 may de-assert the IMON2_REDIRECT signal after the expiration of the replacement period to force multiplexor 423 to select and pass the second voltage (based on IMON2 through second resistor 421) to second transconductance amplifier 422. Accordingly, IMON2 may again be included in its own place for the generation of the summation signal IMON_SUM after the replacement period for IMON2 is complete.

Although examples have been described above, other modifications and variations may be made from this disclosure without departing from the spirit and scope of these examples. The above descriptions of various embodiments illustrate the principles of the invention. Numerous variations and modifications will become apparent to those skilled in the art based on the above disclosure. The following claims are intended to embrace all such variations and modifications.

1. A multi-phase controller for a voltage regulator module, comprising:
a current-mode regulation circuit configured to generate a PWM control signal based on a load condition of the voltage regulator module;
a pulse distributor coupled to receive the PWM control signal from the current-mode regulation circuit and configured to:
distribute pulses to a plurality of power stages, including a first set of pulses to a first power stage and a second set of pulses to a second power stage; and
selectively enable or disable the second set of pulses to the second power stage based on the load condition of the voltage regulator module; and
a current-sense circuit coupled to receive a plurality of current-monitor signals from the plurality of power stages and configured to:
provide a summation signal to the current-mode regulation circuit based on the plurality of current-monitor signals; and
utilize a first current-monitor signal from the first power stage in place of a second current-monitor signal from the second power stage for a replacement period following a resumption of the second set of pulses to the second power stage after a pulse-disable period.

2. The multi-phase controller of claim 1, wherein the current-sense circuit is configured to resume use of the second current-monitor signal for generation of the summation signal after completion of the replacement period.

3. The multi-phase controller of claim 1, wherein the replacement period is in a range from 2.5 to 6.0 μs.

4. The multi-phase controller of claim 3, wherein the replacement period is programmable.

5. The multi-phase controller of claim 1, wherein the current-sense circuit is coupled to receive an N number of current-monitor signals from a corresponding N number of power stages, and wherein the N number is in a range from 2 to 48.

6. The multi-phase controller of claim 1, wherein the current-sense circuit includes:
a summation circuit configured to generate the summation signal based on a plurality of channel signals corresponding to the plurality of current-monitor signals;
a first channel configured to provide a first channel signal to the summation circuit based on the first current-monitor signal from the first power stage;
a second channel configured, when enabled, to provide a second channel signal to the summation circuit based on a selected one of the first current-monitor signal from the first power stage and the second current-monitor signal from the second power stage; and
a redirection controller configured to:
disable the second channel in response to a halting of the second set of pulses to the second power stage;
enable the second channel in response to the resumption of the second set of pulses to the second power stage;
instruct the second channel to select the first current-monitor signal for the replacement period that occurs after the resumption of the second set of pulses; and
instruct the second channel to select the second current-monitor signal after an expiration of the replacement period.

7. The multi-phase controller of claim 6, wherein the redirection controller is configured to instruct the second channel to select the first current-monitor signal after a wait period following the halting of the second set of pulses to the second power stage.

8. The multi-phase controller of claim 6, wherein:
the first channel of the current-sense circuit includes:
a first resistor configured to convert the first current-monitor signal into a first voltage signal; and
a first transconductance amplifier configured to provide the first channel signal to the summation circuit based on the first voltage signal; and
the second channel of the current-sense circuit includes:
a second resistor configured to convert the second current-monitor signal into a second voltage signal;
a multiplexor coupled to pass one of the first voltage signal and the second voltage signal in response to the redirection controller; and
a second transconductance amplifier configured to provide the second channel signal to the summation circuit based on a multiplexor output.

9. A voltage regulator module, comprising:
a plurality of power stages, each including:
a high-side switching transistor;
a low-side switching transistor; and
a current-monitor circuit configured to provide a current-monitor signal representative of a total current through the high-side switching transistor and the low-side switching transistor; and
a multi-phase controller including:
a current-mode regulation circuit configured to generate a PWM control signal based on a load condition of the voltage regulator module;
a pulse distributor coupled to receive the PWM control signal from the current-mode regulation circuit and configured to:
distribute pulses to the plurality of power stages, including a first set of pulses to a first power stage and a second set of pulses to a second power stage; and
selectively enable or disable the second set of pulses to the second power stage based on the load condition of the voltage regulator module; and
a current-sense circuit coupled to receive a plurality of current-monitor signals from the plurality of power stages and configured to:
provide a summation signal to the current-mode regulation circuit based on the plurality of current-monitor signals; and
utilize a first current-monitor signal from the first power stage in place of a second current-monitor signal from the second power stage for a replacement period following a resumption of the second set of pulses to the second power stage after a pulse-disable period.

10. The voltage regulator module of claim 9, wherein the current-sense circuit is further configured to resume use of the second current-monitor signal for generation of the summation signal after completion of the replacement period.

11. The voltage regulator module of claim 9, wherein the replacement period is in a range from 2.5 to 6.0 μs.

12. The voltage regulator module of claim 11, wherein the replacement period is programmable.

13. The voltage regulator module of claim 9, wherein the current-sense circuit is coupled to receive an N number of current-monitor signals from a corresponding N number of power stages, and wherein the N number is in a range from 2 to 48.

14. The voltage regulator module of claim 9, wherein the current-sense circuit includes:
a summation circuit configured to generate the summation signal based on a plurality of channel signals corresponding to the plurality of current-monitor signals;
a first channel configured to provide a first channel signal to the summation circuit based on the first current-monitor signal from the first power stage;
a second channel configured, when enabled, to provide a second channel signal to the summation circuit based on a selected one of the first current-monitor signal from the first power stage and the second current-monitor signal from the second power stage; and
a redirection controller configured to:
disable the second channel in response to a halting of the second set of pulses to the second power stage;
enable the second channel in response to the resumption of the second set of pulses to the second power stage;
instruct the second channel to select the first current-monitor signal for the replacement period that occurs after the resumption of the second set of pulses; and
instruct the second channel to select the second current-monitor signal after an expiration of the replacement period.

15. The voltage regulator module of claim 14, wherein the redirection controller is configured to instruct the second channel to select the first current-monitor signal after a wait period following the halting of the second set of pulses to the second power stage.

16. The voltage regulator module of claim 15, wherein:
the current-monitor circuit of the second power stage is configured to enter a sleep state in response to the second power stage not receiving the second set of pulses for a delay period; and
the wait period for instructing the second channel to select the first current-monitor signal is less than the delay period for the current-monitor circuit to enter the sleep state.

17. The voltage regulator module of claim 14, wherein:
the first channel of the current-sense circuit includes:
a first resistor configured to convert the first current-monitor signal into a first voltage signal; and
a first transconductance amplifier configured to provide the first channel signal to the summation circuit based on the first voltage signal; and
the second channel of the current-sense circuit includes:
a second resistor configured to convert the second current-monitor signal into a second voltage signal;
a multiplexor coupled to pass one of the first voltage signal and the second voltage signal in response to the redirection controller; and
a second transconductance amplifier configured to provide the second channel signal to the summation circuit based on a multiplexor output.

18. A method of operating a multi-phase controller for a voltage regulator module, comprising:
generating a PWM control signal with a current-mode regulation circuit based on a load condition of the voltage regulator module;
distributing pulses, based on the PWM control signal, to a plurality of power stages, including a first set of pulses to a first power stage and a second set of pulses to a second power stage;
selectively enabling and disabling the second set of pulses to the second power stage based on the load condition of the voltage regulator module;
receiving a plurality of current-monitor signals from the plurality of power stages;
generating a summation signal based on the plurality of current-monitor signals;
utilizing a first current-monitor signal from the first power stage in place of a second current-monitor signal from the second power stage for generation of the summation signal for a replacement period in response to a resumption of the second set of pulses to the second power stage after a disable period for the second set of pulses; and
providing the summation signal to the current-mode regulation circuit for regulation of the voltage regulator module.

19. The method of claim 18, further comprising resuming use of the second current-monitor signal for generation of the summation signal after the replacement period following the resumption of the second set of pulses to the second power stage.

20. The method of claim 18, wherein the replacement period is in a range from 2.5 to 6.0 μs.
